(19) United States
(12) Patent Application Publication
(10) Pub. No.: US 2017/0367796 A1
(43) Pub. Date: Dec. 28, 2017

(54) Enossal Single Tooth Implant

(71) Applicant: Epiphanostics GmbH, Holzkirchen (DE)

(72) Inventor: Walter Dürr, Remchingen (DE)

(73) Assignee: Epiphanostics GmbH, Holzkirchen (DE)

(21) Appl. No.: 15/522,806

(22) PCT Filed: Nov. 5, 2015
(86) PCT No.: PCT/DE2015/100472

§ 371 Date: Apr. 28, 2017

(30) Foreign Application Priority Data
Nov. 6, 2014 (DE) 10 2014 116 212.9

(51) Int. Cl. A61C 8/00

(52) U.S. Cl. CPC A61C 8/0068; A61C 8/0086; A61C 8/0012; A61C 8/0022

(57) ABSTRACT

A single tooth implant for a fixed dental prosthesis includes a substantially cylindrical main part which can be inserted into a bore in a jaw bone; an abutment which can be inserted into an annular recess in the main part, the abutment having a bore for receiving a retaining screw and a securing head for the dental prosthesis; and a retaining screw which can be inserted into the blind hole of the main part and traverses the abutment; and at least one annular gap between the abutment and the main part, in which gap a damping element is arranged.

The invention relates to a single tooth implant for a fixed dental prosthesis having the features of patent claim 1.

In the case of a single tooth implant, as is known from DE 40 28 855 C2 and also forms the subject matter of DE 195 09 762.9-32, prevention against rotation is achieved by the main body form-fitting elements at the base of the annular recess of the main body and the spacer socket form-fitting elements, which are complementary thereto, are provided on the cervical end edge of the centring union of the spacer socket. From a production engineering point of view such form-fitting elements are relatively difficult to produce, wherein in some applications it is also particularly advantageous that the full depth of the annular recess or the centring union is not available for centring, fixing and securing the spacer socket relative to the main body.

In another dental implant also, as is provided in DE 37 35 378, similar difficulties occur, based on the fact that the form-fitting elements of the main body are located a distance away from its coronal front edge inside a blind hole of the main body.

DE 41 27 839 A1 discloses an implant main body, the central annular recess of which comprises a form-fitting element which connects directly to the coronal front edge of the main body, wherein the form-fitting element is groove-shaped and the retaining part to be inserted in the main body is designed with a shape complementary thereto. A separate implant abutment or retaining screw is not provided in this case.

DE 195 34 979 C1 discloses a single tooth implant in which the form-fitting elements of the main body are arranged in direct connection to its coronal front edge with corresponding arrangement and design of the complementary abutment form-fitting elements. The fact that the entire depth of the annular recess of the main body is available for centring and guiding the abutment is designed to produce a significantly improved stability of the connection between the spacer socket and the main body while providing a greater design tolerance in the type of division and of the shape of the form-fitting elements.

Common to all of these types of dental implants is the fact that in the coronal area of the main body, as a result of the lateral forces exerted on the crown, considerable stress is generated on the jaw bone on the opposite side of the main body to that on which the forces are applied and so, due to the possible excess load on the bone adjacent to the implant, pressure atrophy and disintegration can occur. In principle—as is also the case for the dental implant—any force exerted on a natural tooth that is elastically suspended in a bony alveole leads to a displacement of the tooth but also to an elastic deformation of the tooth in the longitudinal axis. This displacement and elastic deformation protects against excess strain on the alveolar bone. This physiological tooth mobility differs from the known loosening of teeth in the form of pathological tooth mobility, which can also occur similarly to the processes in connection with the implant main body.

In the prior art in accordance with DE 38 39 724, an enossal single tooth implant having an intermediate element is described, which is intended to perform isolation and damping functions. The intermediate element there, however, fulfils a function which is not satisfactory in all respects, because the lateral forces exerted during chewing are not adequately diverted via the dental implant and implant abutment, and the intermediate element is subject to increased deformation and wear. This allows inflammation sites to form on the implant and to cause bacteria colonisation, which as a result of toxin secretion can cause damage to the soft tissue and therefore the disintegration of the implant.

The inventors have recognized that it is necessary to prevent or at least reduce such a disintegration of the main body due to the lateral forces. The object of the invention is therefore to provide a dental implant in which the development of disintegration due to a combination of mechanical and bacterial stress is prevented, while at the same time supporting the engraftment process, which can take several months from completion of the reconstruction process up to the full strength of the implant in the jaw.

In accordance with the invention this object is achieved in a generic enossal single tooth implant by the combination of the features of the patent claim 1. Advantageous embodiments of the invention are the subject matter of the dependent claims.

The present invention relates to an enossal single tooth implant for a fixed dental prosthesis, having
a substantially cylindrical main body that can be inserted into a bore drilled in a jaw bone, having an annular recess and a bore, arranged coaxially to the annular recess, which comprises a thread for fixing a retaining screw, wherein the annular recess comprises an apical guide section, a form-fitting section and a coronal end section,
an abutment that can be inserted into the recess of the main body with a bore for receiving the retaining screw and with a mounting head for the dental prosthesis, wherein the abutment comprises an apical guide section, a form-fitting section and a coronal end section and
a retaining screw, which can be inserted into the bore of the main body and traverses the abutment,
   wherein the coronal end sections of the abutment and the main body are designed such that after insertion of the abutment in the main body, an annular gap, preferably extending over the entire axial length of the coronal end sections, is formed between the abutment and the main body for receiving a damping element,
   wherein the form-fitting section of the main body and the form-fitting section of the abutment comprise form-fitting elements which are complementary to each other, and when inserting the abutment into the main body are brought into engagement with each other.

In addition, at the coronal end of the end sections of the abutment and the main body a sealing element may be arranged between the abutment and the main body.

By means of the damping element, any physiological interaction in particular during the chewing action can be compensated by loading and relieving, and any disruptive effect on the connective tissue around the implant can be reduced.

The single tooth implant according to the invention therefore comprises a main body, an abutment that can be inserted into the main body and a retaining screw penetrating the main body and the abutment, which fixes the position of the abutment relative to the main body and can be screwed into a threaded section provided at the apical end of the main body.

The body has an annular recess into which the abutment can be inserted. The annular recess therefore comprises a guide section at the apical end of the annular recess, a form-fitting section and a coronal end section, to which the corresponding sections of the abutments are matched in terms of size. The coronal end section in the main body, to which the corresponding section in the abutment is matched, can be designed cylindrical or conical. In the form-fitting section form-fitting elements are arranged, which prevent the relative movement of the abutment and main body in the circumferential direction.

In the region of the coronal end section the abutment and main body are radially spaced apart from each other such that an annular gap is formed for accommodating a damping element. The annular gap is produced due to the different radial diameters of the main body and the abutment in the same plane and is dimensioned such that a damping element is arranged between the abutment and the main body in the manner of a ring or a sleeve, or else in the form of a corrugated sleeve, preferably made of metal such as stainless steel or titanium, in the following called simply a damping element, which can damp forces acting laterally on the single tooth implant, for example via the crown during chewing actions, and at the same time, depending on the material, acting as a sealing element.

This allows the forces acting to be deflected, firstly via the abutment onto the apically placed section or sections of the main body. In particular in the case where the damping element is designed in the form of a corrugated sleeve, a seal, for example an O-ring, can be provided coronally to the corrugated sleeve in a groove on the abutment for sealing between the main body and the abutment. This means that no liquid, such as saliva, can penetrate into the annular gap between the main body and the abutment. The damping element can also be arranged, as for example in the design as a corrugated sleeve, in a recessed (incised) groove section on the abutment, to prevent the damping element from slipping off the abutment when it is pulled out of the main body. In any case, even in this embodiment in the area of the coronal end section the abutment and the main body can be radially spaced apart from each other such that due to the radial spacing of main body and abutment the damping element can still fulfil the damping function. The radial spacing of the main body and abutment in the form of the annular gap according to the invention is not to be equated with a clearance fit, but is much larger than such a clearance fit designed for the component dimensions, so that the damping element can be arranged in the annular gap.

In a further embodiment of the single tooth implant according to the invention for a fixed dental prosthesis, the form-fitting sections of the abutment and main body are designed such that after insertion of the abutment into the main body, an annular gap, preferably extending over the entire axial length of the form-fitting sections, is also formed in the form-fitting section between the abutment and main body, which is designed for receiving a damping element or provides clearance for the mobility of the abutment in the form-fitting region.

In the single tooth implant for a fixed dental prosthesis, the form-fitting section and the coronal end section on the main body can be equiradial to each other in the transition region and the form-fitting section and the coronal end section on the main body can also be equiradial to each other in the transition area.

For example, in the case of a conical end section in the main body, the cone angle in the coronal end section of the abutment can be less than in the main body, so that an axially coronally wedge-shaped extending circumferential annular gap is formed between the main body and abutment. The cone angle is defined as the angle between the longitudinal axis of the implant and the outer surface of the cone.

The damping element is arranged in the annular gap and can be secured relative to the abutment using one or more fixing elements, such as a circumferential collar, groove, peaks or surface wrinkles to prevent slippage when the abutment is inserted into or extracted from the main body. Before the insertion, the sleeve or the ring is pushed over the abutment and secured thereon against displacement via the fixing element or elements.

The damping element in the form of a ring or preferably a sleeve, can be made of PTFE, PVAC or similar polymers or copolymers, which have both a sufficient modulus of elasticity, and also a sufficient mechanical strength to meet the requirements on a permanent basis. Depending on the material used, the damping element can additionally exercise a sealing function. The damping element can also be advantageously provided by spraying a polymer onto at least one component of the main body and particularly the abutment.

Such a damping element, for example as a sleeve, which preferably extends over the entire axial length of the annular gap between the abutment and main body in the coronal end section, can also be made from porous, such as foam-based, material or solid material, wherein as a solid material the embodiment in particular comprises a profiling or a cross-section profile with elevations and/or indentations, which when pressure is applied enable the adaptation to the annular gap with variable cross-section. Thus during insertion of the abutment into the main body, it is possible to adapt the adjacent areas of the damping element to the inner surface of the main body and the outer surface of the abutment. It is also possible to design the damping element in the form of a corrugated (hose)sleeve, which is preferably fabricated from metal as specified above, and which under the action of lateral forces on the crown is compressed on the opposite side to that on which the forces act, and as the force subsides as a result of the return forces is reset back into the starting position. In addition, a seal such as an O-ring can be arranged at the coronal end of the annular gap, as mentioned. Preferably, such a corrugated sleeve is secured against displacement on one side of the abutment via a bead or collar.

After the implantation of an implant according to the invention and adaptation of the crown, as a result of lateral or lateral-axial forces acting on the abutment via the crown during the chewing action, an axial flexing of the abutment can occur, which are in turn laterally damped by the damping element and can be diverted onto the apical sections of the main body arranged in the jaw. Thus the coronal sections, and in particular the area of the coronal alveolar wall, are relieved of the action of the force.

This protects against bone loss and a transformation of the bone into a connective tissue encapsulation around the implant in the jaw.

The guide section and the form-fitting section can also be designed as a single form-fitting guide section, which at the same time fulfils the functions of guiding the abutment in the main body and providing a form-fitting connection between the abutment and the main body to prevent rotation. In particular, this is possible if the form-fitting guide section is designed as a cylindrical section with axial grooves on one component and with cams which engage in the grooves on the other component. In this case the design of the main body with axial cams that engage in axial grooves on the abutment is preferred.

The guide section on the main body and abutment are each designed in the manner of a clearance fit with one another. This enables a reliable guiding of the abutment in the main body. In the case that the guide section and the form-fitting section are designed as two distinct sections, when inserting the abutment the guide section engages before the form-fitting section is brought into engagement.

In the case of such a clearance fit the maximum radial dimension of the guide section of the abutment is smaller than the minimum radial dimension of the guide section of the main body. The tolerance ranges are selected such that the maximum clearance, i.e. the maximum radial distance between the minimum dimension of the guide section of the abutment and the maximum dimension of the guide section of the main body, obtains a value sufficient for the insertion resistance and guiding.

According to the invention, it is also possible to design the apically arranged guide section on the main body as a hollow cylinder and the coronal form-fitting section thereto and the end section in a continuously conical form, and on the abutment to design the apically arranged guide section with a clearance fit relative to the guide section of the main body, the form-fitting section being conical with the same cone angle as in the form-fitting section on the main body and the coronal end section being conical with a smaller cone angle compared to the form-fitting section.

In a particular embodiment of the enossal single tooth implant according to the invention, in particular with a conical form-fitting section arranged between the apical guide section and the coronal end section, the apical guide sections of the abutment and main body are designed such that after insertion of the abutment into the body a conical or cylindrical annular gap, preferably extending over the entire axial length of the apical guide section, is formed between the abutment and main body for receiving an apical damping element, for example in the form of an elastic sleeve or a compensator, e.g. made of stainless steel as described above. The apical damping element arranged in the annular gap can be formed of the same material as the damping element in the coronal end section, but preferably has a higher material hardness/lower elasticity and is also used for guiding the guide section of the abutments in the guide section of the main body. In this design of the enossal single tooth implant according to the invention with an apical damping element, in the event of a lateral force acting on crown placed on the abutment a damped “pendulum-like” (rod-like) movement of the abutment can take place above and below the conical form-fitting section in the annular recess of the main body. The pivot point of the abutment is in the region of the form-fitting section or apically below it. In a cylindrical design of the form-fitting section the movement can take place over the entire length of the cylindrical sections (guidance section, form-fitting section and end section) and the pivot point of the abutment lies in the apical region of the guide section. In these embodiments there is sufficient clearance available in the form-fitting section to enable an oscillatory motion about the respective pivot points, as indicated above. Advantageously, this embodiment of the enossal single tooth implant according to the invention interacts with an apical damping element and with a coronal damping element with the preferably swivel-ring-shaped collar on the abutment, described in the next section, which can be supported on the front edge of the main body, thus enabling a supported pendulum-like motion of the abutment.

Preferably, the enossal single tooth implant according to the invention for a fixed dental prosthesis has an abutment with a collar facing the main body, which is arranged above the coronal end section of the abutment and is conical or swivel-ring-shaped and can be supported on the spherical-segment-ring-like front edge of the main body. This means that, under the action of lateral forces and an axial flexing of the abutment, the abutment can be supported on the main body in an inclined position and after the force is removed is able to “spring back” into the normal position.

In order to enable the main body to be securely screwed into the jaw of the patient, and in the process to allow sufficient torque to be applied to the main body without the form-fitting elements being damaged even when the diameter or angle of the bore in the jaw is not exactly matched, it is possible to provide in the form-fitting section, the guide section or a single form-fitting guide section of the main body, in addition to the form-fitting elements, form-fitting screw-in elements, in the following abbreviated to screw-in elements, which after insertion of the screwing-in tool, such as a screw bit with customized tool head, produce the form fit between the screw-in element on the main body and the screw-in element on the screwing-in tool, for example in the manner of a male-part and female-part connection, and so enable the main body to be screwed into the jaw.

After screwing the main body into the jaw and withdrawing the screwing-in tool, the abutment can be inserted in the main body so that it is circumferentially alignable, enabling the form-fitting elements on the main body and abutment to be brought into engagement with each other and in the process, fix the positions of the main body and abutment relative to each other. Then the main body and abutment are fixed in position relative to each other via the retaining screw. A form-fit between the screw-in elements on the main body and the form-fitting elements on the abutment is preferably not provided according to the invention.

This therefore allows the main body, as a result of the design of the main body according to the invention with the screw-in elements, using a tool which engages with the screw-in elements, to be screwed into the jaw bone with increased torque compared to the designs from the prior art. Although the screw-in elements can be provided in each of the two sections (centring/guide section at the apical end of the annular recess and the form-fitting section), the screw-in elements are preferably arranged in the cylindrical or preferably conical form-fitting section between the apical guide section and the coronal end section. A form fit or force fit between the screw-in elements on the main body and the form-fitting elements on the abutment is preferably not provided according to the invention.

A conical form-fitting section increases the diameter of the guide section to the diameter of the end section and is formed on the main body in the shape of a hollow frustum, which mates with a frustum on the abutment. In principle, the form-fitting section on the main body can also be designed as a hollow cylinder, wherein in that case the at least one form-fitting element and the at least one screw-in element can lie on parallel radial planes, but the design of the form-fitting section as a hollow frustum on the main body is preferred.

In the region of the form-fitting section, which as indicated can be cylindrical or conical, the screw-in elements on the main body can be arranged in the circumferential direction preferably between the form-fitting elements on the main body, which can be brought into engagement with the form-fitting elements on the abutment, and are preferably interleaved.

With regard to the screw-in elements, in principle it is possible to arrange the male part(s) on the main body and the female part(s) on the screwing-in tool or vice versa, wherein the design with the arrangement of the male part(s) on the screwing-in tool and the female part(s) on the body is preferred.

The screw-in elements can each be designed in the form of a recess on the body and a nose or projection on the screwing-in tool that engages in the recess. Of these, the design of at least one, in particular two, three or four, recess(s) in the form-fitting section on the main body is preferred.

The screw-in elements can each be designed in particular in the form of two or more, preferably three or four to six, coaxial plane surfaces, preferably arranged evenly spaced circumferentially in the annular recess on the main body, and the tool in the form of a screwing-in tool with a three-sided, four-sided or multi-sided head.

In the form-fitting section therefore, recesses and main-body-abutment form-fitting elements, the latter as anti-rotation protection, can be arranged so that in the form-fitting region screw-in elements and main-body-abutment form-fitting elements are preferably arranged alternately around the circumference.

For example, on the main body two, three or four recesses are provided as screw-in elements and in each case one main-body form-fitting element is provided between two adjacent screw-in elements. On the abutment, form-fitting elements corresponding to the main body form-fitting elements are preferably provided in sufficient number to allow an alignment of the abutment. In the case of two, three or four main body form-fitting elements on the main body, for example, two, three, four, six, eight, nine or more matching form-fitting elements can be provided on the abutment.

According to the invention the form-fitting section of the main body and the form-fitting section of the abutment are matched to each other in terms of their shape, so that the abutment can be inserted into the recess of the main body, so that the respective form-fitting elements can be brought into engagement with one another and thus prevent any movement in the circumferential direction. The respective form-fitting sections can be designed as hollow frustum-shaped or hollow cylindrical regions of the annular recess or bore, or else with sections having different diameters, in the main body, and in each case an external cylindrical section or sections of the abutment corresponding thereto.

The design according to the invention of the enossal single tooth implant allows the use of different materials and material combination, which can be selected from the group of metals, the metallic alloys, ceramic materials and combinations thereof.

The implant preferably consists of a material selected from the group of metals, the metallic alloys, ceramic materials and combinations thereof. The implant material used preferably consists of metallic materials such as pure titanium or metallic titanium alloys, chrome/nickel/aluminium/vanadium/cobalt alloys (e.g. TiAIV4, TiAlFe2,5), stainless steels (e.g., V2A, V4A, chromium-nickel 316L), ceramic materials such as hydroxyl apatite, aluminium oxide, zirconium oxide or a combination thereof, in which the metallic material is present as a composite material with ceramic material.

The following description of the elements of the invention applies to all embodiments, unless stated to the contrary.

The guide section in the base body adjoins the threaded section for the retaining screw, which is arranged in the apical end of the main body. In a coronal direction relative to it, the form-fitting section is arranged, in which at least one, in particular two, three or four screw-in elements and at least one, in particular two, three or four or more main-body-abutment form-fitting elements are provided. Also in the coronal direction relative thereto the end section is arranged, in which a sealing element can be provided between the main body and the abutment. The sealing element can be designed in the form of an elastic seal which is arranged in a groove in either of the main body or the abutment.

The axial lengths of guide section, form-fitting section and end section can be dimensioned such that the apical guide section and coronal end section are each longer than the form-fitting section.

In accordance with the invention the preferably cylindrical guide section provided axially and apically to the form-fitting section allows a reliable and stable fixation of the abutment in the main body by the retaining screw, since abutment and main body are mounted via the guide section with a clearance fit in the manner of a pipe-in-pipe fitting. The radial internal diameters of the guide section in the main body and the outer diameter of the abutment are chosen such that the wall thickness in the main body is sufficient to prevent plastic deformation of the main body walls under the action of lateral or angular stress on the implant during a chewing action. This also applies in a corresponding way to the embodiment of the enossal single tooth implant according to the invention with an additional damping element in the region of the guide sections of the main body and abutment, as is described below.

In one embodiment according to the invention, the form-fitting section of the main body can be designed in particular as a hollow frustum or a partial form thereof. In this case, the form-fitting section of the abutment is designed as a solid frustum corresponding to the hollow frustum.

In this embodiment the form-fitting section of the main body is designed as a hollow frustum with one circular surface having a smaller diameter (top surface) and with one circular surface having a larger diameter (base surface), wherein the longitudinal axis of the hollow frustum is arranged coaxially to the longitudinal axis of the main body, the circular surfaces adjoin the hollow frustum and the circular surface with the larger diameter is facing the coronal end of the main body.

As a result of the design of the main body according to the invention with the screw-in elements, by means of a tool that engages with the screw-in elements the main body can be screwed into the jaw bone with increased torque compared to the designs from the prior art, and after insertion into the main body the abutment is reliably secured against rotation by means of the form-fitting elements with mutually complementary shapes.

According to the invention, the mutually complementary form-fitting elements on the main body and abutment are each designed in the form of a male-part to female-part connection, wherein the male part(s) is/are preferably arranged on the main body. On the basis of the arrangement thus selected, due to the avoidance of any reduction in the wall thickness of the main body, a precise force transmission is possible even with ceramic materials, which enables the use of a fully or partially ceramic main body and/or abutment, in addition to the known metals and alloyed materials. But it is also possible for the male part(s) to be arranged on the form-fitting section of the abutment and the corresponding female parts to be arranged on the main body.

In accordance with the invention, each male-part form-fitting element can have the form of a spring bar which extends parallel to the longitudinal axis of the main body, and in each case engages in a corresponding female part on the other component (abutment) secured against rotation. The form-fitting elements can be cut from the components of the main body and the abutment by mechanical machining methods, such as milling, drilling etc.

The form-fitting section can be designed cylindrically or preferably conically. In the case of a cylindrical design the form-fitting section on the abutment is designed in the form of a cylindrical section, which with its outer diameter is matched in length and diameter to the hollow cylindrical bore on the main body.

If the form-fitting sections are designed as a hollow frustum on the main body and a frustum on the abutment, the at least one spring bar is designed such that the spring bar, depending on whether it is arranged on the main body or abutment, is radially convex about the longitudinal axis of the main body or abutment and axially tapers towards it in a wedge shape in the direction of the larger diameter of the frustum or hollow frustum, without increasing the diameter of the larger circular surface which closes off the frustum. The maximum radial height of the spring bar therefore corresponds to the difference in the radii of the circular surfaces closing off the frustum or hollow frustum, minus any clearance.

According to the invention, the spring bar can be advantageously designed in the form of a nose which is milled out of the main body, or of a pin which is held in a blind hole (retaining hole), wherein the blind hole can be provided coaxially to the longitudinal axis of the main body in the conical region of the hollow frustum or frustum, depending on the relative position of the male or female part in the body or the abutment, up to the region parallel to the threaded section. As a result of the conical surface on the hollow cone, or frustum, each pin is at least partially guided in a groove with a decreasing cross section towards the end opposite to the retaining hole, which results in a kind of wedge shape of the spring bar. In order to make the wall thickness in the form-fitting section as thick as possible, depending on the relative position of the male or female part in the main body or the abutment, the blind hole for receiving the pin or groove is arranged such that the outline of the hole touches the outline of the circular surface tangentially at the apical end, or the hole is arranged partially within the circular surface at the apical end.

The pins can each have a preferably circular, or regularly or irregularly polygonal cross-section, of which one cross-section segment protrudes from the groove in the conical wall radially to the direction of the longitudinal central axis, depending on the relative position of the male or female part, of the main body or the abutment, and can form the spring bar beyond the maximum axial length of the form-fitting section. In the simplest form a pin can have a cylindrical shape and be produced, for example, in a wire drawing machine. It is thus possible to produce the pin from a material with higher strength than the material for the abutment or main body, so that the force can be transmitted accurately via the form-fitting elements or screw-in tool.

In order to secure the pin axially, each pin can be fitted/plugged into the blind hole using a press fit.

To facilitate the ability to insert the abutment in different positions around the circumference, the form-fitting elements relative to the circumference of the abutment and main body can have an angular division, which allows an insertion of the abutment into the main body in different positions, such as a 15, 30, 45, 60, 90, 120, or 180 degree division. Also, the number of the female-part form-fitting elements can be greater than or equal to, for example, depending on the division, two or three times the number of those of the male-part form-fitting element. The preferred combination is of one form-fitting element, such as a pin, on the main body with one to six form-fitting elements such as grooves on the abutment, or accordingly two form-fitting elements on the main body and two, four or six form-fitting elements on the abutment, three form-fitting elements on the main body and three or six form-fitting elements on the abutment, or four form-fitting elements on the main body and four or eight form-fitting elements on the abutment, wherein the form-fitting elements in each case are regularly spaced over the circumference.

In one embodiment according to the invention, the abutment can comprise a bearing collar for the noses or pins of the main body in the form-fitting section. When inserting the abutment into the main body the noses or pins can rest with their respective coronal end at least partly on the bearing collar, the maximum width of which may correspond to the diameter but in particular to the radius of a pin, and when the abutment is rotated for the radial alignment of the abutment in accordance with the requirements of the implant dentist, said noses or pins snap into the form-fitting grooves.

For the implant abutment(s)/retaining screw, a female thread can be provided apically in the blind hole from the conical form-fitting and centring section of the main body, wherein the retaining screw can also completely traverse the abutment.

In addition, the invention also relates to a main body and an abutment as individual components of the implant according to the invention, which are designed completely in accordance with the embodiment details for the implant.

Another aspect of the present invention is that in addition to a simplified mechanical machining of the components of main body and abutment, which are each manufactured with corresponding form-fitting elements in the form of the above described tongue and groove connection in a centring and guide region, a balanced mechanical stability can be achieved in the mounting of the implant in the jaw and in its use during the chewing process, while at the same time preventing the loosening of the implant, which in the systems known in the prior art is not the case. At the same time, compared to the known solutions from the prior art the machining of the blanks of the main body and the abutment is significantly simplified and more cost-effective.

In the following, exemplary embodiments of the single tooth implant according to the invention and its components are described in detail by reference to the schematic drawings. These show:

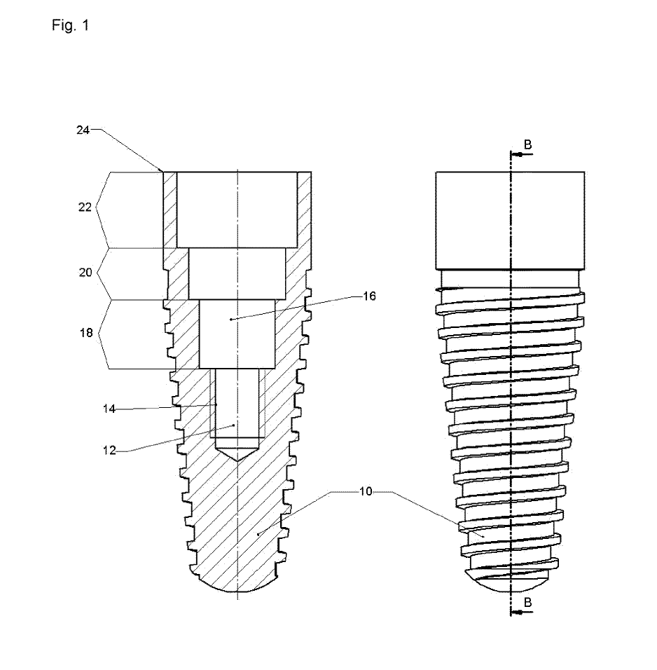

FIG. 1 an exemplary embodiment of a main body of an implant according to the invention in an axial longitudinal section along the plane shown on the right in plan view;

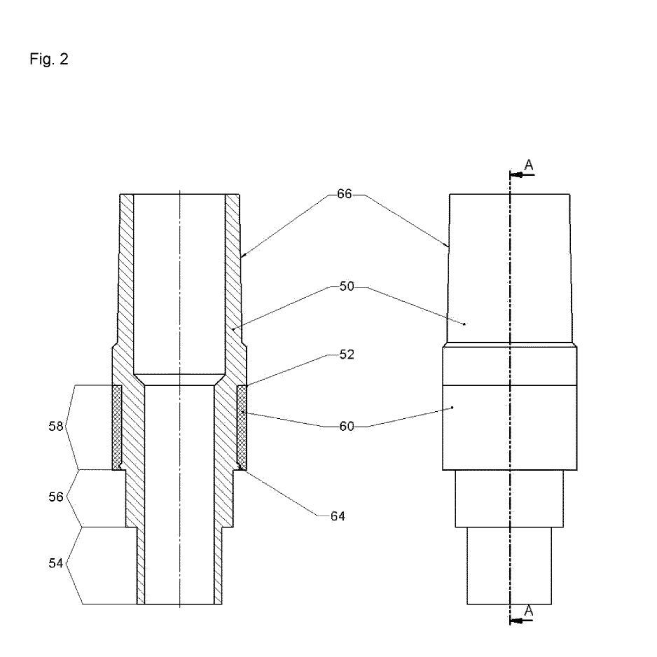

FIG. 2 an exemplary embodiment of an abutment of an implant according to the invention in an axial longitudinal section along the plane shown on the right in plan view, which can be inserted into the main body shown in FIG. 1;

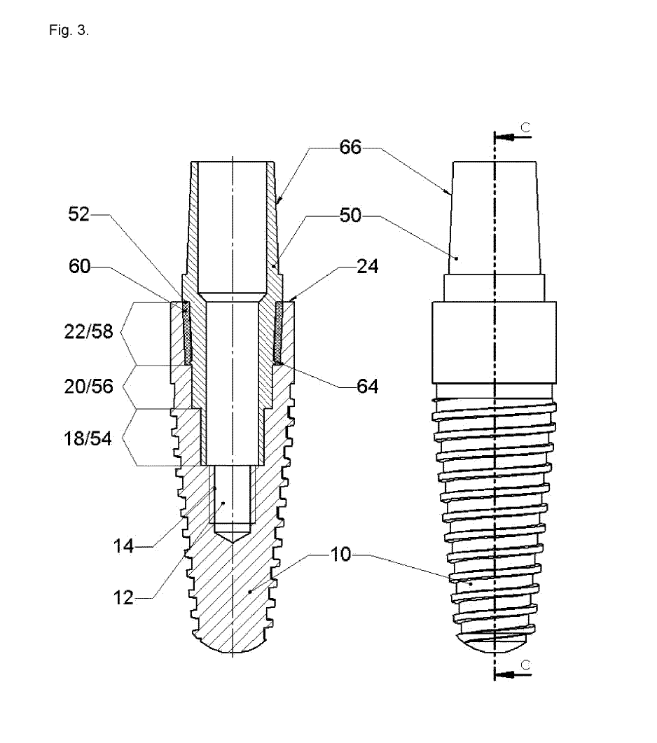

FIGS. 3-5 further exemplary embodiments of an enossal single tooth implant according to the invention in axial longitudinal section along the plane shown on the right in plan view;

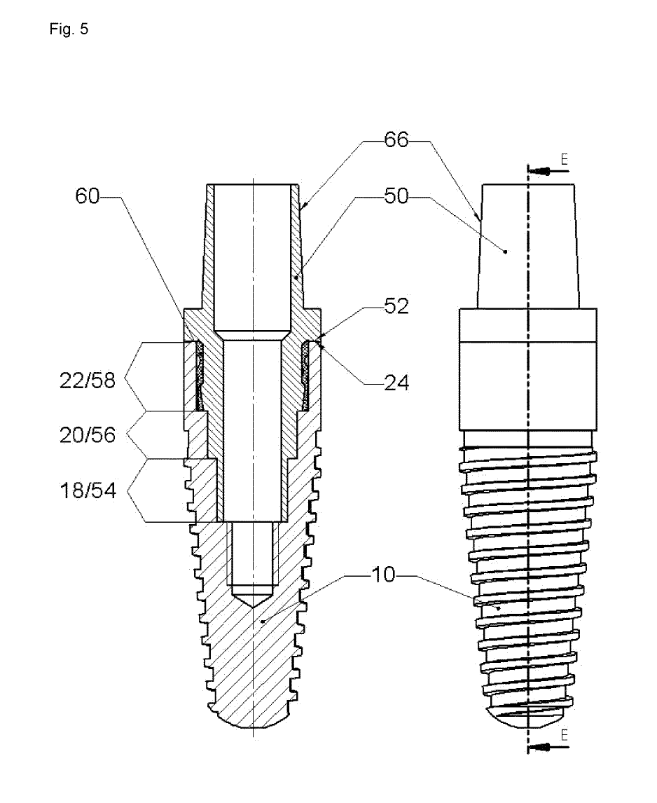

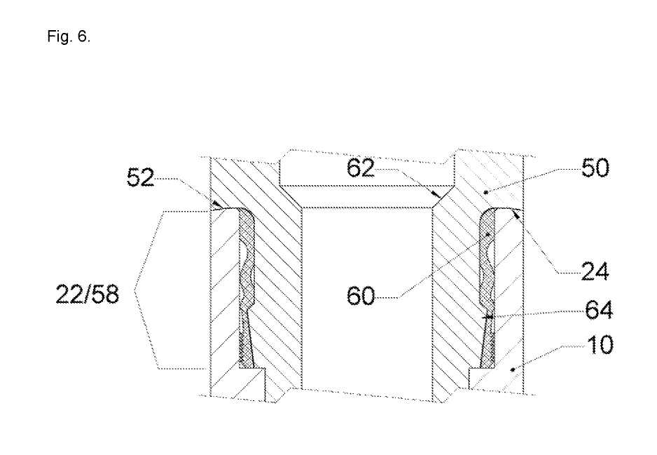

FIG. 6 a detail view taken from FIG. 5 in the axial longitudinal section in plan view,

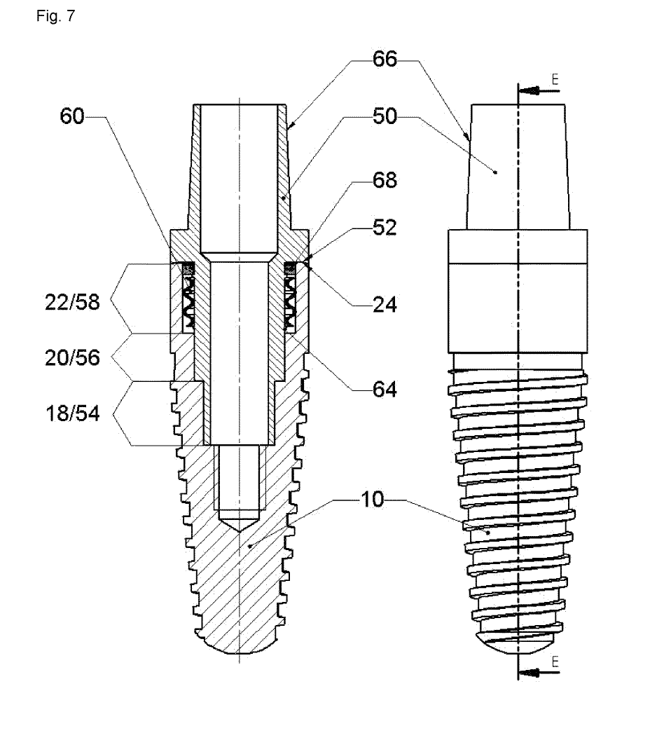

FIG. 7 a further exemplary embodiment of an enossal single tooth implant according to the invention having a corrugated sleeve in an axial longitudinal section in the central area, and on the right in plan view.

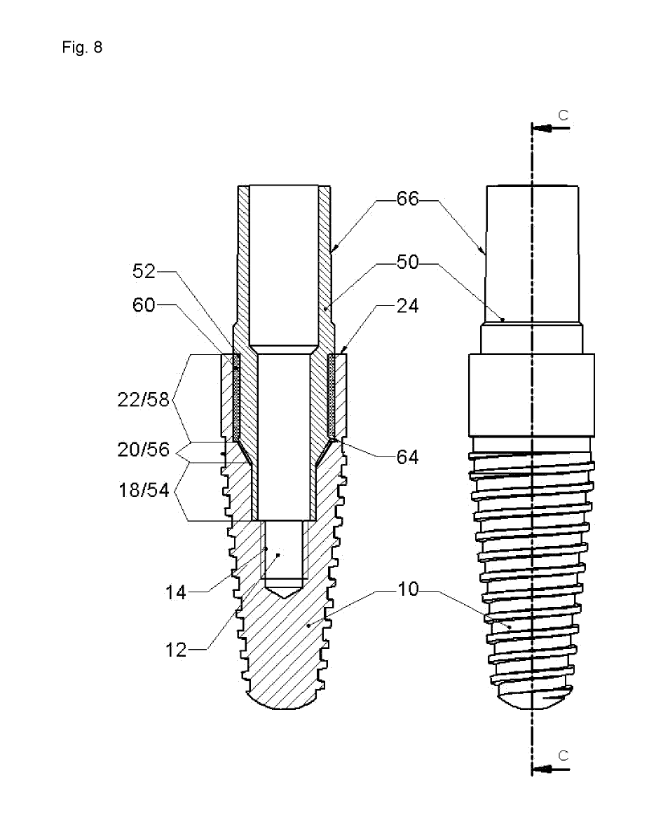

FIG. 8 a further exemplary embodiment of an enossal single tooth implant according to the invention in axial longitudinal section along the plane shown on the right in plan view having a conical form-fitting section;

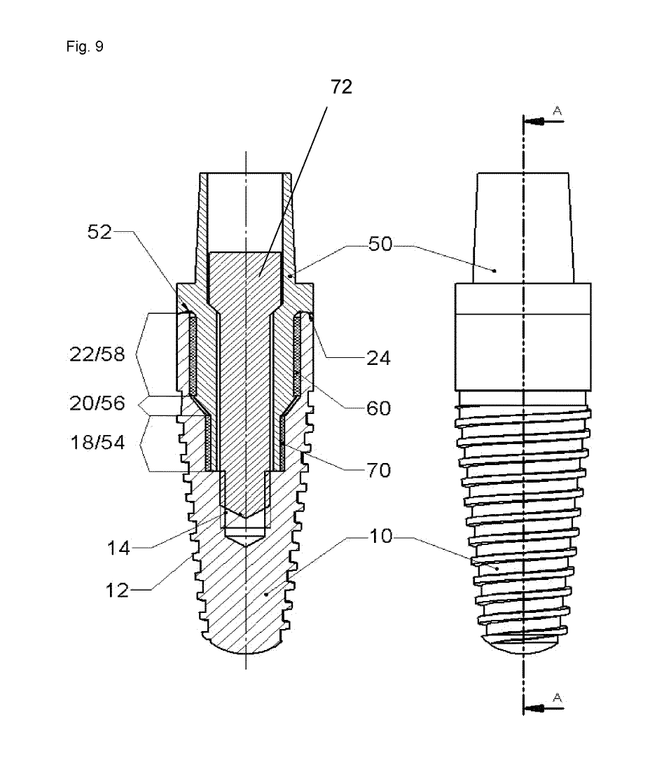

FIG. 9 a further exemplary embodiment of an enossal single tooth implant according to the invention in axial longitudinal section along the plane shown on the right in plan view having a conical form-fitting section and a further apical damping element;

As FIG. 1 shows, the exemplary embodiment shown there comprises a main body 10, which is closed at its apical end shown at the bottom of FIG. 1, and a blind hole 12 which is open at its coronal end, located at the top of FIG. 1, with a female thread 14. Into the female thread a retaining screw, not drawn in FIG. 1, can be screwed. The female thread 14 of the main body 10 is connected in the coronal direction to a hollow cylindrical annular recess 16 with a larger inside diameter compared to the female thread 14. The annular recess 16 in the form described comprises three regions (18; 20; 22).

The annular recess 16 comprises a guide section 18, which joins coronally to the female thread 14. The guide section 18 of the annular recess 16 connects in the coronal direction to a form-fitting section 20, which has an inside diameter that increases in the coronal direction compared to the guide section 18, and comprises a cylindrical inner wall having form-fitting elements, not shown in the embodiment according to FIG. 1, in the form of, for example, three radially inward-facing spring bars. The spring bars are designed to correspond to form-fitting grooves on the abutment, not shown in FIG. 2, in the manner of a tongue and groove connection and can be dimensioned in such a way that they extend over the entire axial length of the form-fitting section 20. These spring bars can be formed from the main body by machining. It is, however, also possible advantageously to design the spring bars by the fact that pins are held in the form-fitting section in axial retaining groove holes evenly distributed over the circumference. Each of the pins with a cross-section matched to the retaining groove hole, for example as a cylindrical pin, can be plugged into the retaining groove hole in the wall of the form-fitting section 20 and held by the retaining groove partially radially enclosed in the form-fitting section 20, in such a way that a radially inward-facing spring bar, which corresponds to the form-fitting groove of the abutment 50 according to FIG. 2, is formed. This enables, already during insertion of the abutment 50 into the main body 10, guiding of the abutment through the guide section 18 between the spring bars, preferably three or four spring bars equidistantly distributed over the circumference.

In the form-fitting section 20 the main body 10 is connected in the coronal direction to an end section 22, cylindrical in this embodiment, having a coronal front edge 24. The end section 22 has an inner wall corresponding to the outer diameter of the end section 58 of the abutment 50 in accordance with FIG. 2, wherein a gap is formed for receiving a damping element 60 in the form of a ring, or preferably a sleeve. The damping element can be secured against slipping on the abutment 50 shown in FIG. 2 via one or a plurality of fixing elements, such as a circumferential triangular collar or beading 64. The main body 10 in the region of the front edge 24 can be larger in diameter than the collar 52 provided on the abutment 50, and for example, the diameters of the main body 10 and abutment 50 in the transition region can be of the same size. The collar 52 on the abutment thus limits the axial displaceability of the damping element (here a sleeve) 60. Abutment 50 is used for fixing a fixed dental prosthesis, not shown, via the mounting head 66. Accordingly, at the coronal end of the abutment 50 a mounting head 66 is provided, having components for mounting a dental crown that are not shown.

In the form-fitting section 20, three or more recesses or internal triangular faces, not shown in FIG. 1, are provided as screw-in elements, into which the corresponding noses or external three-sided (or more) faces on the screwing-in tool can engage during the process of screwing the main body 10 into the jaw.

The main body 10 and the abutment 50 shown in FIG. 2 can be produced in a simple manner by machining of blanks. Advantageously for this process is in particular the design of the spring bars as cylindrical pins (not shown), arranged in each case in a retaining groove hole in the form-fitting section 20 of the main body 10. Thus before forming the form-fitting section, holes can be bored coaxially to the blind hole 12 into the walls in the guide section 18 of the main body 10, and during milling of the form-fitting section 20 with a bevel cutter, can be formed in the form-fitting section 20 and in the wall as retaining groove holes. Correspondingly, the grooves can be formed on the abutment.

Even though the use of cylindrical pins is advantageous from a manufacturing point of view, it is also possible to use pins with a regular or irregular polygonal cross-section and a retaining groove hole with an appropriately matched cross-section and matched form-fitting groove.

During insertion of the abutment 50 shown in FIG. 2, which is provided with an axial longitudinal bore whose inner diameter is approximately equal to the outer diameter of the retaining screw, not shown in FIG. 1, in the main body 10, the guide section 54 engages with the guide section 18 of the annular recess 16, wherein the smooth cylindrical outer surface of the of the guide section 54 comes to rest on the cylindrical inner surface of the guide section 18 of the main body 10.

By means of the retaining screw, not shown in FIG. 1, which penetrates the abutment 50 shown in FIG. 2, and which can be screwed into the female thread 14 of the main body 10, the abutment can be rigidly connected to the main body 10. In order to facilitate the removal of the abutment 50 from the main body 10, in the bore penetrating the abutment a female thread, not shown in FIG. 1, can be provided, into which after removal of the retaining screw an impression post, not shown, with a male thread can be screwed, which is supported with its apical end on the female thread 14 of the main body. When screwing in the impression post, the abutment 50 is then lifted out of the main body 10 coronally and can be removed.

Depending on the division or sub-division ratio of the main body 10 or the abutment 50, the abutment 50 can be inserted in the main body 10 in different rotary positions, for example in a DEG division of 30°, 45°, 60°, 90°, 120° or 180°, which provides the treating dentist with a number of configuration options. The number of preferred abutment form-fitting elements used is greater than that of the main body form-fitting elements. Thus configurations of two pins as form-fitting elements in the main body 10 and two, four, six, eight, ten or twelve form-fitting grooves as form-fitting elements on the abutment 50, or in particular of three pins in the main body 10 and three, six, nine or twelve form-fitting grooves on the abutment 50, are advantageous. In the context of the invention, instead of an abutment for a single tooth implant a prosthetic structure element is also encompassed, which can be blocked, for example, with another prosthetic structure element in an adjacent main body in the jaw or can bridge an interdental gap to another prosthetic structure element in the jaw by means of a bridge element, as long as the design according to the invention makes use of at least one damping element as described above.

The embodiment of the implant according to the invention shown in FIG. 3 is almost identical in design to the embodiment of main body 10 and abutment 50 shown in FIGS. 1 and 2, except that the end section 22 on the main body 10 and the end section 58 on the abutment are conical, and implemented as a hollow frustum on the main body 10 and as a solid frustum on the abutment 50. The sleeve arranged between main body 10 and abutment 50 in the coronal end section (22;58) has a constant thickness over the axial length and thus a roughly trapezoidal cross section in a longitudinal section.

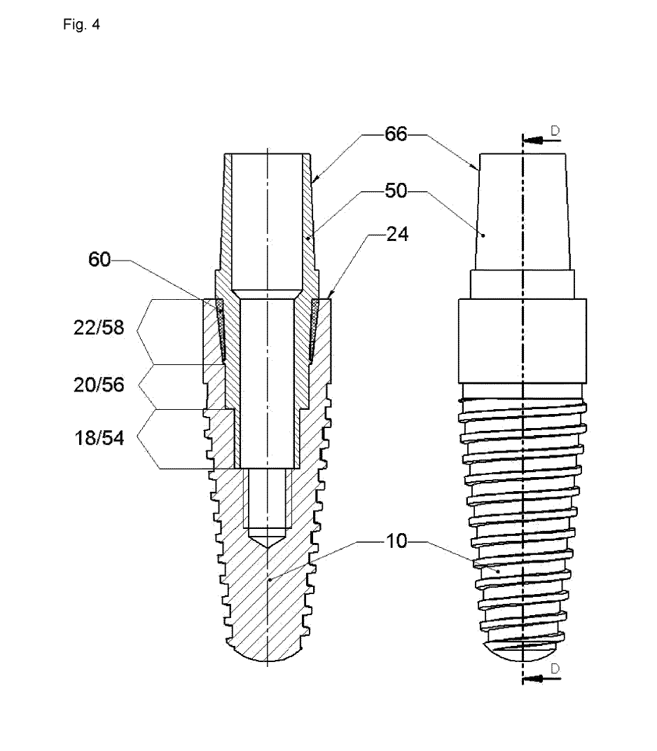

The embodiment of the implant according to the invention shown in FIG. 4 is almost identical in design to the embodiment shown in FIG. 3, wherein the end section 22 on the main body 10 and the end section 58 on the abutment are both conical, and implemented as a hollow frustum on the main body 10 and as a solid frustum on the abutment 50. In the coronal end section (22;58) the cone angle on the main body 10 can be equal to or, as shown, greater than the cone angle on the abutment 50, so that the sleeve arranged between main body 10 and abutment 50 in the coronal end section (22; 58) has a coronally increasing thickness over the axial length, and thus an approximately wedge-shaped cross section. This embodiment according to FIG. 3 allows an improved dissipation of the lateral forces acting on the dental crown from the area of the face edge 24 onto the main body 10.

The embodiment of the implant according to the invention shown in FIG. 5 uses a main body 10 similar to the embodiment of the main body shown in FIG. 2, except that the sleeve 60 arranged between end section 22 on the main body 10 and end section 58 on the abutment 50 comprises a cross-sectional profile shown in the detail view of FIG. 6 with recess and profiling sections. In addition, in this embodiment, radially at least partially overlapping, the front edge 24 of the main body 10 and the collar 52 of the abutment overlap, wherein said collar is arranged above the coronal end section 58 of the abutment 50 and is conical or swivel-ring-shaped and can be supported on the spherical-segment-ring-like front edge 24 of the main body. This means that, under the action of lateral forces and an axial flexing of the abutment, the abutment can be supported on the main body in an inclined position and after the force is removed is able to spring back into the normal position.

In the detail view of the embodiment of the implant according to the invention shown in FIG. 6, the detail view shows in the area of the end section (22; 58) the spherical-segment-ring-like design of the front edge 24 of the main body 10 that abuts against the collar 52 of the abutment 50, which is designed as a spherical segment-ring, and thus facilitates the cervical mobility of abutment 50 with respect to main body 10. In the end section 58 on the abutment 50, the sleeve 60 is arranged, which has a cross-sectional profile shown in the detail view with recesses and profiled sections and is secured against slipping when extracting the abutment 50 via the triangular collar/beading 64. The retaining screw, not shown in FIG. 6, comes to rest on the bearing collar 62 if the main body 10 and abutment 50 are fixed to each other by screwing the retaining screw into the female thread 14.

The schematic sectional view of an implant according to the invention shown in FIG. 7 shows the corrugated sleeve arranged in a groove section on the abutment 50 as a damping element 60, which is arranged in the annular gap between the abutment 50 and main body 10. The ingress of fluid into the annular gap between the main body 10 and abutment 50 can be prevented by means of the sealing ring 68. The protection against slippage 64 in the form of a circumferential elevation/collar/beading can prevent slipping of the corrugated sleeve provided as a damping element 60 during extraction of the abutment 50 from the main body 10. The corrugated sleeve 60 is preferably axial shorter than the end section, in order to facilitate the axial extension (elongation) of the corrugated sleeve under lateral stress.

The embodiment of the implant according to the invention shown in FIG. 8 uses a main body 10 similar to the embodiment shown in FIG. 2, except that the form-fitting section 20 on the main body 10 and the form-fitting section 56 on the abutment 50 each have matching conical shapes, in which form-fitting elements are arranged which can be brought into engagement with each other during insertion of the abutment 50 into the main body 10. In addition, in the form-fitting region 20 on the main body 10, the aforementioned screw-in elements can be provided in the form of recesses and/or internal polygonal surfaces, in particular two to six screw-in elements and preferably arranged alternately with the form-fitting elements, which allow the main body 10 to be screwed into the jaw with a dental tool having a tool head similar to an

Allen key. In addition, if desired, in this embodiment, radially at least partially overlapping, the front edge 24 of the main body 10 and the collar 52 of the abutment can overlap, wherein said collar is arranged above the coronal end section 58 of the abutment 50 and is conical or swivel-ring-shaped and can be supported on the spherical-segment-ring-like front edge 24 of the main body. This means that, under the action of lateral forces, the abutment can be supported on the main body in an inclined position and after the force is removed, is able to spring back into the normal position in a rod-like manner.

The embodiment of the implant according to the invention shown in FIG. 9 comprises a form-fitting section 20 on the main body 10, similar to the embodiment shown in FIG. 8, and a form-fitting section 56 on the abutment 50, each having matching conical shapes, wherein form-fitting elements are arranged in the form-fitting sections, which elements can be brought into engagement with each other during insertion of the abutment 50 into the main body 10. The conical form-fitting section can be designed in the shape of a spherical-segment ring on the main body and swivel-ring-shaped on the abutment, wherein the abutment 50 is supported on the spherical segment on the main body 10 via the swivel ring and can support the oscillatory motion. In addition, the embodiment shown in FIG. 9 comprises a further (apical) damping element 70, which is arranged in a gap between the guide section of the abutment and main body and is arranged either on the guide section of the abutment (preferred) or in the hollow cylindrical guide section of the main body. Thus, during insertion of the abutment 50 this damping element can be used for guiding into the main body 10, and on the other hand when the retaining screw 72 is fixed in place, to exercise the damping function during the chewing process. In this embodiment also, in the form-fitting region 20 on the main body 20, screw-in elements can be provided in the form of recesses and/or internal polygonal surfaces, in particular two to six screw-in elements, and preferably arranged alternately with the form-fitting elements, which allow the main body 10 to be screwed into the jaw with a dental tool having a tool head similar to an Allen key. In addition, in this embodiment if desired, radially at least partially overlapping, the front edge 24 of the main body 10 and the collar 52 of the abutment can overlap, wherein said collar is arranged above the coronal end section 58 of the abutment 50 and is conical or swivel-ring-shaped and can be supported on the spherical-segment-ring-like front edge 24 of the main body. This means that, under the action of lateral forces and a bending of the retaining screw of the abutment, the abutment can be supported on the main body in an inclined position and after the force is removed the retaining screw (and therefore the abutment) springs back into the normal position in a rod-like manner. This movement is indicated in FIG. 9 by the arrows to the right and left of the longitudinal axis line and is present in all embodiments according to the invention.

### LIST OF REFERENCE NUMERALS

10 main body
12 bore
14 female thread
16 annular recess
18 guide section
20 form-fitting section
22 end section
24 front edge
50 abutment
52 collar
54 guide section
56 form-fitting section
58 end section
60 damping element (coronal)
62 bearing collar of the retaining screw
64 anti-slip protection
66 mounting head
68 sealing ring
70 damping element (apical)
72 retaining screw

1. Enossal single tooth implant for a fixed dental prosthesis, having
a substantially cylindrical main body that can be inserted into a bore drilled in a jaw bone, having an annular recess and a bore arranged coaxially to the annular recess, which comprises a thread for fixing a retaining screw, wherein the annular recess comprises an apical guide section, a form-fitting section and a coronal end section,
an abutment that can be inserted into the recess of the main body, having a bore for receiving the retaining screw and a mounting head for the dental prosthesis, wherein the abutment comprises an apical guide section, a form-fitting section and a coronal end section and
a retaining screw, which can be inserted into the bore of the main body and traverses the abutment, and
a damping element in the form of a sleeve,
wherein the coronal end sections of the abutment and the main body are radially spaced apart and designed such that after insertion of the abutment into the main body, an annular gap, extending over the entire axial length of the coronal end sections, is formed between the abutment and the main body for receiving the damping element,
wherein the form-fitting section of the main body and the form-fitting section of the abutment comprise form-fitting elements which are complementary to each other, and are brought into engagement with each other when inserting the abutment into the main body.

2. Enossal single tooth implant for a fixed dental prosthesis according to claim 1, wherein the coronal end sections of the abutment and the main body are designed cylindrical, wherein, after inserting the abutment in the main body, an annular gap, preferably extending over the entire axial length of the coronal end sections, is formed between the abutment and the main body for receiving the damping element.

3. Enossal single tooth implant for a fixed dental prosthesis according to claim 1, wherein the coronal end sections of the abutment and main body are designed conically, such that after insertion of the abutment in the main body, an annular gap, preferably extending over the entire axial length of the coronal end sections, is formed between the abutment and the main body for receiving the damping element, wherein the cone angle of the coronal end section of the abutment is less than or equal to the cone angle of the coronal end section of the main body.

4. Enossal single tooth implant for a fixed dental prosthesis according to claim 1, wherein the form-fitting sections of the abutment and main body are designed cylindrical, conical or dome-like and complementary to each other.

5. Enossal single tooth implant for a fixed dental prosthesis according to claim 3 wherein the form-fitting section and the coronal end section on the main body are equiradial to each other in the transition region and the form-fitting section and the coronal end section on the abutment are equiradial to each other in the transition region.

6. Enossal single tooth implant for a fixed dental prosthesis according to claim 1, wherein the form-fitting sections of the abutment and the main body are designed such that after insertion of the abutment in the main body, an annular gap, preferably extending over the entire axial length of the form-fitting sections, is formed between the abutment and the main body.

7. Enossal single tooth implant for a fixed dental prosthesis according to claim 1, wherein the damping element is designed in the form of a profiled sleeve.

8. Enossal single tooth implant for a fixed dental prosthesis according to claim 1, having a second damping element wherein the apical guide sections of the abutment and the main body are designed such that after insertion of the abutment in the main body, an annular gap, preferably extending over the entire axial length of the apical guide sections, is formed between the abutment and the main body for receiving the second damping element, wherein the second damping element is designed in the form of a profiled sleeve.

9. Enossal single tooth implant for a fixed dental prosthesis according to claim 8, in which the apical guide sections of the abutment and the main body are cylindrical or conical.

10. Enossal single tooth implant for a fixed dental prosthesis according to claim 1, wherein a collar of the abutment facing the main body, said collar being arranged above the coronal end section of the abutment, is swivel-ring shaped and is supported on a spherical-segment-ring shaped front edge of the main body.

11. Enossal single tooth implant according to claim 1, wherein the mutually complementary form-fitting elements of the form-fitting sections of the abutment and main body are designed in the form of at least one male-part to female-part connection between the main body and abutment.

12. Enossal single tooth implant according to claim 11, in which the respective male part is arranged on the main body as a form-fitting element and the corresponding mother part is arranged on the abutment as a form-fitting element.

13. Enossal single tooth implant according to claim 11, in which the respective male-part to female-part connection is formed by the fact that at least one spring bar extending parallel to the longitudinal axis of the main body is arranged on the main body and engages with a corresponding groove on the abutment in a manner secured against rotation.

14. Enossal single tooth implant according to claim 1, wherein in addition to the mutually complementary form-fitting elements, at least one, preferably two to six, screw-in elements acting in the circumferential direction is/are provided, for the engagement of a screwing-in tool in the guide section or preferably in the form-fitting section.

15. Enossal single tooth implant according to claim 14, in which two to six screw-in elements acting in the circumferential direction and the mutually complementary form-fitting elements are arranged alternately in the form-fitting section.

16. Enossal single tooth implant according to claim 1, wherein the mutually complementary form-fitting elements have, with respect to the circumferences of the main body and the abutment, angular divisions matching to each other.

17. Enossal single tooth implant according to claim 1, wherein the number of the female-part form-fitting elements is greater than that of the male-part form-fitting elements.
